(19) United States
(12) Patent Application Publication
(10) Pub. No.: US 2002/0023083 A1
(43) Pub. Date: Feb. 21, 2002

(54) Systems and methods for enabling an untrained or novice end-user to rapidly build clinical trials data management systems compliant with all appropriate regulatory guidances

(76) Inventor: Wesley Paul Durkalski, Charleston, SC (US)

Correspondence Address: OPPAENHEIMER WOLFF & DONNELLY LLP, ATTN: MARC E. BROWN, ESQ., 38TH FLOOR, 2029 CENTURY PARK EAST, LOS ANGELES, CA, 90067, US

(21) Appl. No.: 09/836,653

(22) Filed: Apr. 17, 2001

Related U.S. Application Data
(60) Provisional application No. 60/197,648, filed on Apr. 17, 2000.

(51) Int. Cl. G06F 7/00

(52) U.S. Cl. 707/3

(57) ABSTRACT

Systems and methods for enabling an untrained or novice end-user to rapidly build clinical trials data management systems that are compliant with all appropriate regulatory guidelines are disclosed. An exemplary embodiment is a software package, executed by a computer, that contains a specified knowledge base of clinical trials regulations and provides an interactive venue through which information and specifications for a particular clinical trial is collected by the user. The knowledge base of clinical trials regulations and the user-provided information are combined by the software to produce a set of “creation rules” unique to the particular clinical trial. The creation rules are then utilized by the software to automatically generate a clinical trials database management system, that is customized specifically to the particular clinical trial and adheres to the appropriate regulations that must govern the particular clinical trial.

### RELATED APPLICATIONS

This Application claims priority of U.S. Provisional Application No. 60/197,648, filed Apr. 17, 2000, incorporated herein by reference.

### BACKGROUND OF THE INVENTION

1. Field of the Invention

This invention relates to clinical trials and systems for managing their administration. More particularly, the invention relates to database management systems used in the administration and management of clinical trials.

2. General Background and State of the Art

Biomedical research has made extraordinary progress in recent years, one outcome of which is the development of new drugs at a rapidly increasing rate. Current demand for improved healthcare is providing additional impetus for the high rate of new drug and pharmaceutical research and development. With this substantially increased production of new drugs and pharmaceuticals comes an increased demand for clinical trials, which are used to validate the new treatments. Clinical trials are, in fact, a requirement for agency registration of a new drug.

Clinical trials have been an important part of the medical community's research and development efforts for more than one hundred years. In a clinical trial, a pharmaceutical, device, or procedure is evaluated for safety, efficacy and efficiency against currently existing products. These trials often involve human subjects, but can also take place using animals or lab cultures. In all cases, the trials involve analysis of results through careful study of the trials' data.

To enable valid analysis of study results, clinical trials require the collection, management, and study of enormous quantities of data. Massive amounts of data are often produced in the course of a single, individual clinical study. Yet a complete clinical trial investigation often requires numerous individual clinical studies. These multiple studies, usually necessary for agency registration of a new drug, may generate nearly unmanageable amounts of data. These data, even in seemingly unmanageable quantities, must be efficiently organized and managed for a successful clinical trial.

Organization and management of large amounts of data by a computer is often handled by a database. Databases are collections of information organized in such a way that a computer program can quickly select desired pieces of data. In a sense, a database is an electronic filing system. Traditional databases are organized by fields, records, and files. A field is a single piece of information, a record is one complete set of fields, and a file is a collection of records. For example, a telephone book is analogous to a file. It contains a list of records, each of which consists of three fields: name, address, and telephone number.

To access information from a database, a database management system (DBMS) is typically utilized. This is a collection of programs that enables a user to enter, organize, and select data in a database. Over the past twenty years, various database management systems have become available to assist users with the development and administration of clinical trials, due to their ability to manage the large amounts of data generated by these trials. Generally, these software applications have been designed to assist users with various tasks, that may be categorized as either design, data collection, or data cleaning tasks. Design tasks include specification of data fields, specification of forms which may be collections of fields either on paper or on-screen, and specification of the underlying database that will be used to collect data. Data collection tasks include those tasks relevant to processes used to transfer collected data into a database. Data cleaning tasks are those which apply to processes used to ensure that collected data reflect reality as closely as possible.

In addition to these three categories of tasks that are typically required in a clinical trials database management system, such a system must also account for federal regulations and guidelines relating to clinical trials. That is, clinical data analysis and clinical trials results ultimately must adhere to the federal regulations applicable to clinical trials. Because these regulations are particularly voluminous, and because every clinical trial will have its own requirements and specifications, the creation of a database management system that adheres both to the clinical trial's specifications and to the relevant regulations and rules as set forth by the government becomes a highly specialized task resulting in a unique database management system for each clinical trial. Normally, the creation of a system for one clinical trial requires the exclusive employment of a professional who is specifically trained in the creation of clinical trials management systems. The set-up process typically requires several weeks of the professional's time. This necessary customization, and the resultant specialized development process, translate to substantial costs for creating a clinical trials database management system.

In addition to the substantial costs associated with the creation of a clinical trials database management system, the subsequent use of known clinical trial data management software systems require users to incur additional, and significant, costs for training and licensing. For example, the complexity of known clinical trial data management systems generally requires initial training courses for all users, and may even require regular and ongoing expenditures for training. Additionally, many of these systems utilize privatized industry-standard databases, such as Oracle, and therefore require licensing fees as well as responsibility and additional costs for maintaining the licensed database.

More recently, developers of clinical trials management systems have attempted to reduce users' database maintenance cost obligations by operating on the world wide web or other computer network. This makes multiple user access to a single, central database an affordable alternative to self-maintenance of expensive personal databases. However, these systems remain costly, as they place other, burdensome requirements on users. For example, users of web- or network-based systems are typically required to purchase and maintain a central server with specified software to host the clinical trial software, or to provide all computer, network, and server data security. These requirements are not only burdens on a user's time and labor resources, but they also incur substantial financial burdens on the user.

In addition to their high cost requirements, known prior art systems require users to have programming knowledge, product specific training, and/or programming support offered by the vendor to enable a user to learn how to program the software to build a clinical trials management system. Although databases can be powerful tools for maintaining and accessing large amounts of data, therefore, the complexities inherent to clinical trials and associated regulations cause currently known and used clinical trial data management software development systems to be very expensive and, in some cases, cost prohibitive. Clearly, databases as currently utilized in the management of clinical trials are too complex, time consuming, and expensive to provide efficient and affordable solutions to the problems generally associated with the management of clinical trials.

### INVENTION SUMMARY

The present invention enables a user without training or programming knowledge to rapidly build a clinical trials database management system (CTDBMS). The invention provides a novel system that creatively combines the immense data capacity of database management systems with the customization features necessary to accommodate complexities unique to clinical trials specifications and related guidelines, to truly utilize the full potential of each.

More specifically, the present invention provides CTDBMS users with a unique utility that enables the development, creation, and implementation of a customized CTDBMS without the need for expensive, specialized developers or costly training and licensing requirements. To achieve this previously unavailable user-enabled CTDBMS customized creation system, a built-in knowledge base of clinical trial database functions and standards is combined with the results of an interactive basic information query to the user, and the appropriate CTDBMS software is automatically generated for the user. As a result, the present invention makes it possible for a user with no programming experience to not only implement and use a CTDBMS with minimal or no training, but also to create one or more CTDBMS software applications by simply providing basic information related to a specific clinical trial. Moreover, the present invention makes it possible to develop, generate and operate a CTDBMS entirely within a single Web page or at a common Web site. The novel self-contained Web-based CTDBMS is an exemplary embodiment of the present invention which can eliminate the need for costly, external databases and computers. Alternatively, software for establishing a CTDBMS creation system may be stored on various electronic storage media including but not limited to floppy disks, magnetic tape, optical disks, hard disk storage, and the like.

In one embodiment of the invention, the CTDBMS creation system comprises a software utility application. Basic clinical trial information is provided by the user to the CTDBMS creation system in an interactive format, such as through dialogue data input boxes, which appear on a computer monitor and receive input through a computer keyboard. The CTDBMS creation system software analyzes the basic information in combination with the information resident in its built-in knowledge base of clinical trial database functions and standards. The result of the analysis is a customized CTDBMS that adheres both to the user's specifications relating to the specific clinical trial as well as to the appropriate regulations and guidelines that are to govern the clinical trial. This unique self-customization ability translates to a substantial cost reduction through the elimination of the specialized development, training and licensing costs that are inherent to prior art systems.

In addition to these cost savings, the present invention also has the advantage of not requiring costly hardware and software specifications because the user is not required to provide a centralized server or software environment. Further, security may be provided in some embodiments of the present invention by widely adopted Internet security methods, eliminating certain security related costs borne by the users of web- and network-based prior art systems. In view of these new cost savings, and in contrast to prior art systems, the present invention provides the ability to self-produce, implement, and use a customized CTDBMS at a previously unknown low level of cost and with greatly reduced requirements of the user.

The foregoing and other objects, features, and advantages of the present invention will be become apparent from a reading of the following detailed description of exemplary embodiments thereof, which illustrate the features and advantages of the invention in conjunction with references to the accompanying drawing Figures.

### BRIEF DESCRIPTION OF THE DRAWINGS

FIG. is a diagram illustrating the structure of a system according to one embodiment of the invention.

FIG. 2 is a diagram illustrating the administrative portion of a system according to one embodiment of the invention.

FIGS. 3a and 3b illustrate exemplary dialogue boxes that may be implemented in the administrative portion of one embodiment of the invention.

FIG. 4 is a diagram illustrating the steps involved in trial design according to one embodiment of the invention.

FIG. 5 is a diagram illustrating the steps involved in forms design according to one embodiment of the invention.

FIG. 6 is a diagram illustrating the steps involved in the design of the validation portion of a system according to one embodiment of the invention.

FIG. 7 is a diagram illustrating the steps involved in the subjects management portion of a system according to one embodiment of the invention.

FIG. 8 is a diagram illustrating the steps involved in the data management portion of a system according to one embodiment of the invention.

FIG. 9 is a diagram illustrating the steps involved in the data retrieval management portion of a system according to one embodiment of the invention.

FIG. 10 is a diagram illustrating the steps involved in the study completion management portion of a system according to one embodiment of the invention.

### DETAILED DESCRIPTION OF THE PREFERRED EMBODIMENTS

In the following description of the preferred embodiments reference is made to the accompanying drawings which form the part thereof, and in which are shown by way of illustration specific embodiments in which the invention may be practiced. It is to be understood that other embodiments may be utilized and structural and functional changes may be made without departing from the scope of the present invention.

As illustrated in FIG. 1, an exemplary embodiment of the present invention is a clinical trials management system comprising multiple components packaged as a single product, such as a software suite or software package, indicated at trial management home 102. Components of the software suite or software package comprise algorithms, routines, or other software embodiments. The various components, according to the exemplary embodiment of the invention, are an administrate component 104, a design component 106 and a manage component 108. Each of these components will be described herein according to exemplary embodiments with reference to the subsequent Figures. In the description, the term “users” will be used to describe persons who utilize a CTDBMS after it has been created, and the term “developer” will be used to describe a person who utilizes an embodiment of the invention, such as a computer executing a software package, to create the CTDBMS.

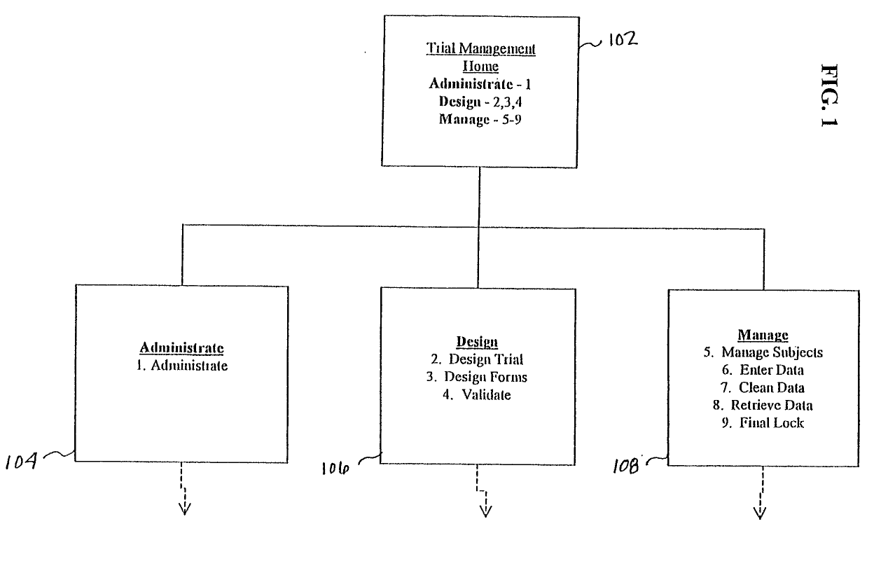

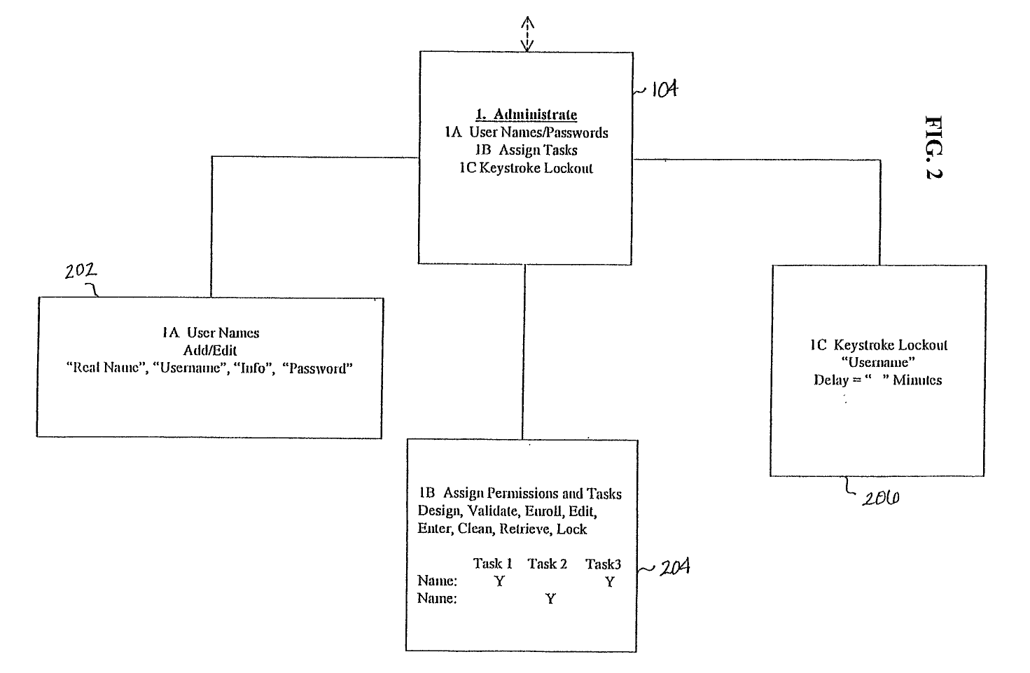

Administrate component 104 is illustrated in FIG. 2. In the exemplary embodiment, this component is software designed to manage, for example, names and passwords of users of the system, assignment of the users' tasks, and security features. Through the use of dialogue boxes, developers may enter these, and other, pieces of information during a set-up process, so that a CTDBMS will be generated with appropriate administrative information that is specific to the particular clinical trial. For example, as shown in block 202 in FIG. 2, user names may be added to the CTDBMS, or edited subsequent to their entries, by the developer. These additions or edits may involve a user's real name, his CTDBMS-specific username and password, and other such identifying features. Task assignment may be defined by a developer as indicated at box 204, also through a dialogue box presented to the developer by the software. Once user names have been entered and recognized by the system, these names can be associated with specific tasks and permissions. For example, a first user may be associated with permissions to clean data and edit names, while a second user may be associated with design and validation tasks. This assignment feature provides security beyond the protection offered by username/password methods, such that even users who are enabled to enter the CTDBMS via a username and password, can be limited from being able to access all portions of the CTDBMS by being denied permissions to those portions. A third administrative function, also a security feature, is keystroke lockout, indicated at block 206. Here, a username may be associated with a keystroke lockout time, such that if no keystrokes are made by the user while logged in for the specified keystroke lockout time, the CTDBMS automatically logs that user out.

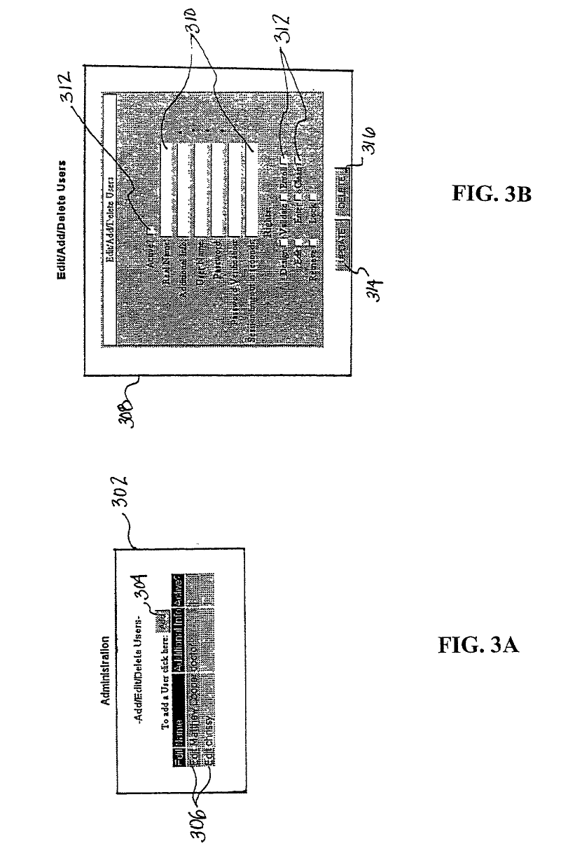

FIG. 3 illustrates dialogue boxes exemplary of those which may be used by embodiments of the invention to create a CTDBMS. For example, FIG. 3A illustrates an interactive box 302 for the addition or editing of users. To add a user, a developer can activate a button 304. Similarly, to edit a user, a developer can activate a hyperlink 306. In either case, the activation may be accomplished by a mouse, a keyboard, or other computer peripheral. In both cases, the activation will cause the software to display an appropriate dialogue box. For example, if a developer has activated “add” button 304, dialogue box 308 will appear on the computer screen. Various fields 310 in the dialogue box will accept data from the developer, as through a keyboard. These fields will accept data relating to the real name, username, password, and other identifying information for a particular user. Dialogue boxes may also contain toggle options 312, activated by a mouse. An “update” button 314 may be activated to prompt another dialogue box that will enable the developer to view and edit information about a user that has already been added to the CTDBMS. Similarly, a “delete” button 316 may be activated to prompt a dialogue box that will enable the developer to remove a user from the CTDBMS.

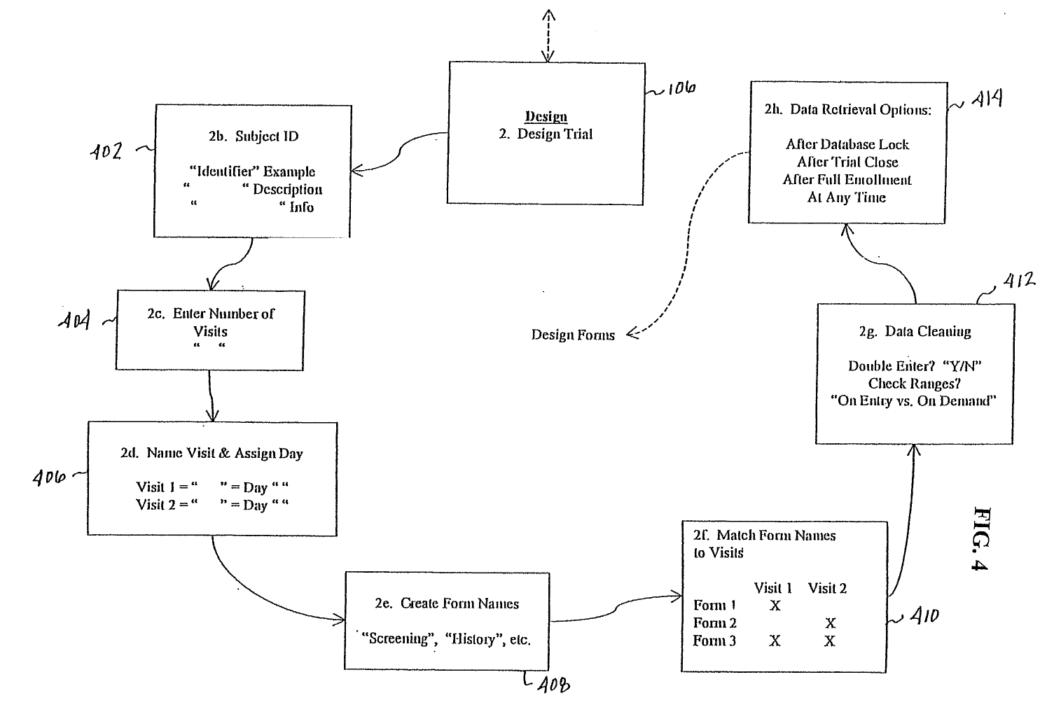

The trial design portion of design component 106 is illustrated in FIG. 4. In the exemplary embodiment, this portion is software specialized for designing aspects of the clinical trial that will be managed by the CTDBMS being created by the developer. As shown at box 402, the trial design begins with creating subject identifications to be used during the clinical trial. The developer enters an identifier, description, or other label for each user. This identifier may be a name, a number, or a combination of letters and numbers. The developer will also define the number of visits for each subject, as indicated at box 404. A visit is considered to be any instance or point in time when data will be collected for entry in trial forms. Some examples would be an office visit, a phone interview, or a collection of lab results. As indicated at box 406, each type of visit will be anticipated and accordingly named by the designer, and may also be assigned a day, to indicate a particular sequence or time at which the visit occurs. As indicated at box 408, the developer also establishes and enters a form name for each of the forms that will be used to enter data for the clinical trial. For example, a form may be named “Phone Screen Log,” “Subject Medical History,” or “Subject Symptom Survey.” Once form names are prescribed and visit days are assigned, the developer can match the appropriate forms with each of the visits, as indicated at box 410. This provides for the CTDBMS, once generated, to provide users with forms appropriate for the subject of a visit on the day in which that visit occurs. As indicated at box 412, the developer may select various options that the clinical trial will use for data cleaning. These may include double entry, which requires data to be entered twice to assure validity through duplication of entry, or range checking, which checks for unordinary or unexpected data. Also, the developer establishes the time during the clinical trial at which users will be allowed to retrieve data, as indicated at box 414.

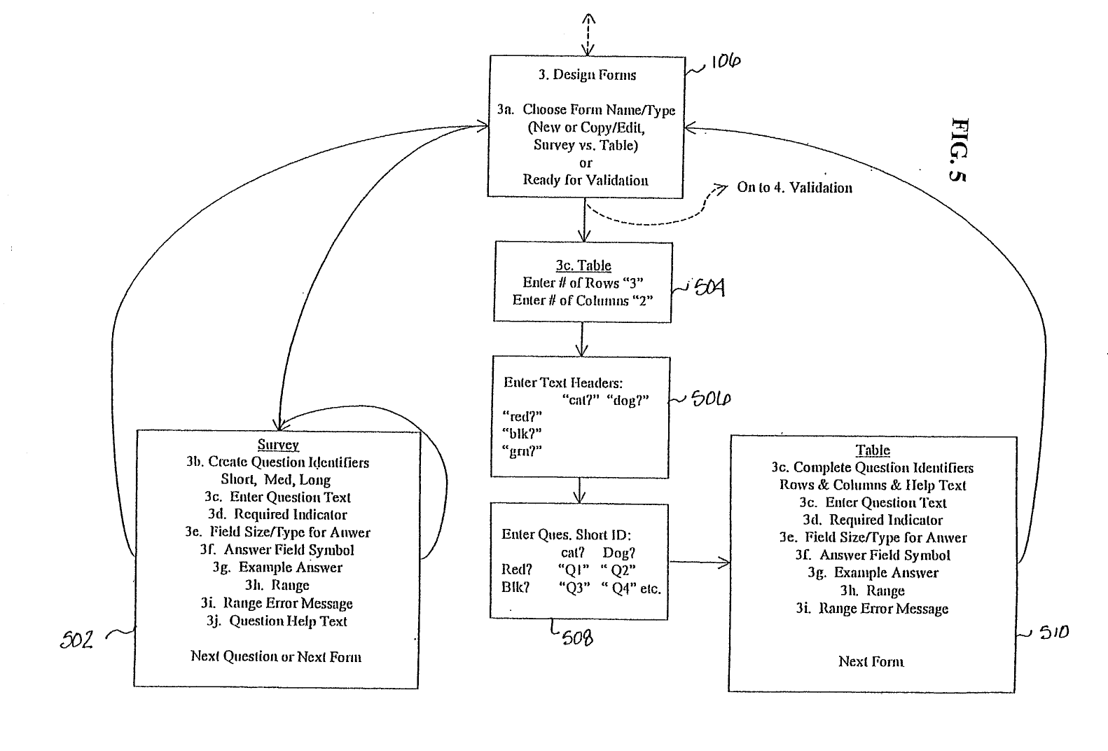

The forms design portion of design component 106 is illustrated in FIG. 5. In the exemplary embodiment, this portion is software that enables the designer to enter the questions that will appear on each form and also enter all information associated with the questions. First, the format of the form is selected. If the developer selects a survey format for the form, as indicated at box 502, the developer is then provided with a dialogue box for entering the survey content. Such content may include a question, the amount of space available for an answer, the error message that will appear in the case where a range error occurs during survey completion, or instructional information for providing help to a user during survey completion. A survey form is then generated, with fields appropriate for answering the survey questions. If, on the other hand, the developer selects a table format for the form, as indicated at box 504, additional information is required from the developer. Here, the developer specifies the number of rows and the number of columns to be included in the table. As shown at box 506, the developer also enters text headers for each of the columns and rows. The developer also enters question identifiers at box 508. These identifiers provide efficient indication of which questions assigned to and answered in each cell of the table. Every cell can be defined by a unique row and column combination. The full text of the question, in addition to information similar to that discussed in the case of a survey format, is then entered to complete the design for a table format form, as indicated at box 510.

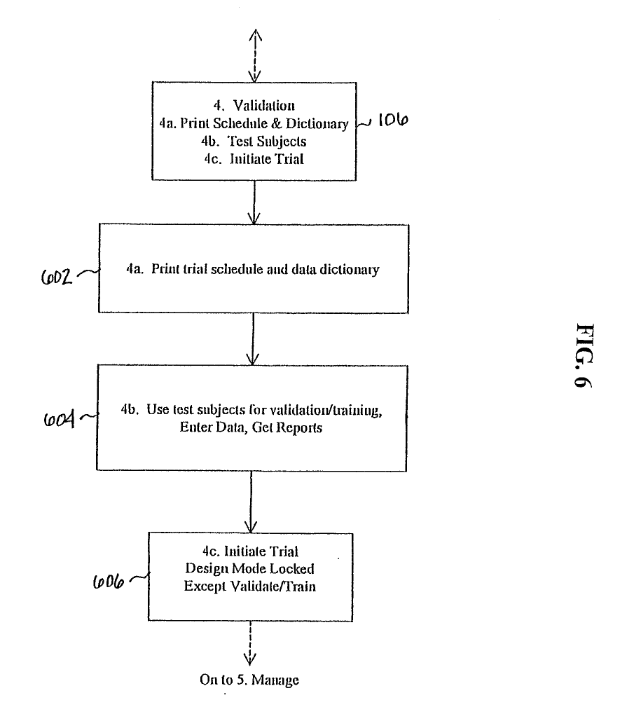

The validation design portion of design component 106 is illustrated in FIG. 6. In the exemplary embodiment, this portion is software used by the developer to review all of the work done for the setup of the clinical trial. As shown at box 602, the developer can print copies of the trial schedule and data dictionary, which give an overview of the visits to occur during the clinical trial, the days on which the visits will occur, and the types of data that will be collected. Once these parameters are verified, the developer may utilize test subjects for validation of the CTDBMS operation as well as for training purposes. As indicated at block 604, this phase involves entering data into the forms that have been designed for the clinical trial and having the CTDBMS generate reports. After this phase, the developer proceeds to trial initiation, indicated at block 606. Here, the developer accepts all previous work and allows the program to prepare the customized clinical trial database.

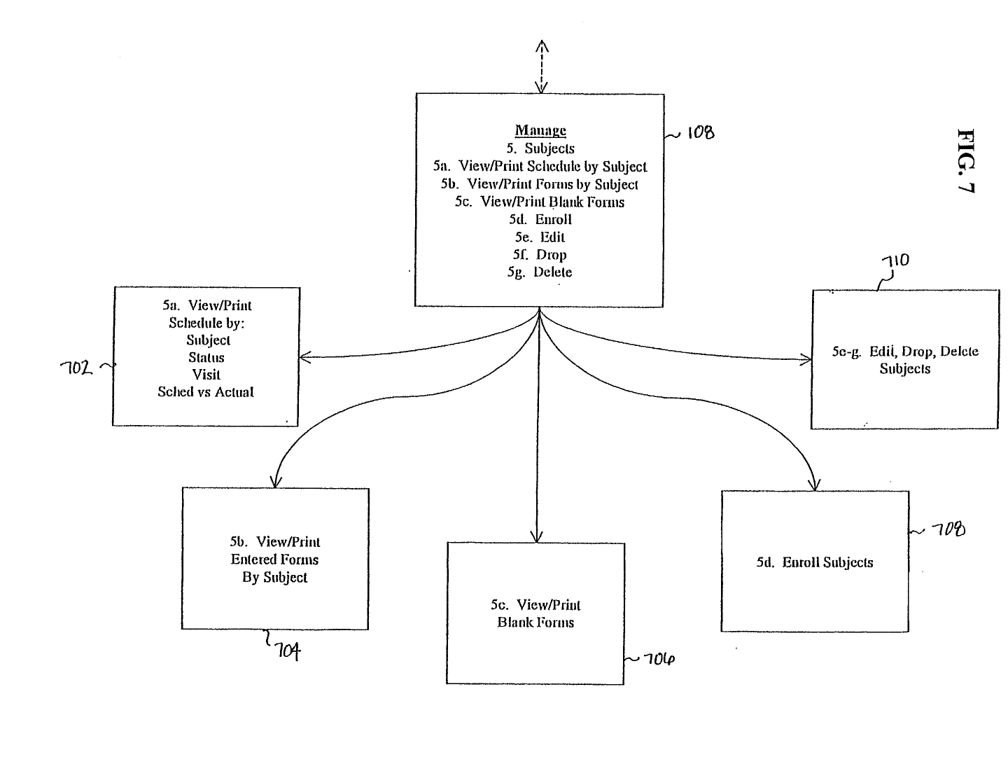

Once the customized CTDBMS has been developed, users may begin to use it for implementation and management of the clinical trial. The subjects management portion of manage component 108 is illustrated in FIG. 7. In the exemplary embodiment, this portion is software that allows users to view or print any one of a subject's schedule as indicated at box 702, a form entered with data collected from a subject as indicated at box 704, or blank forms that have no data entered. A user may also use this portion of the software to enroll subjects as indicated at box 708 or to edit, drop, or delete subjects from the clinical trial, shown at box 710.

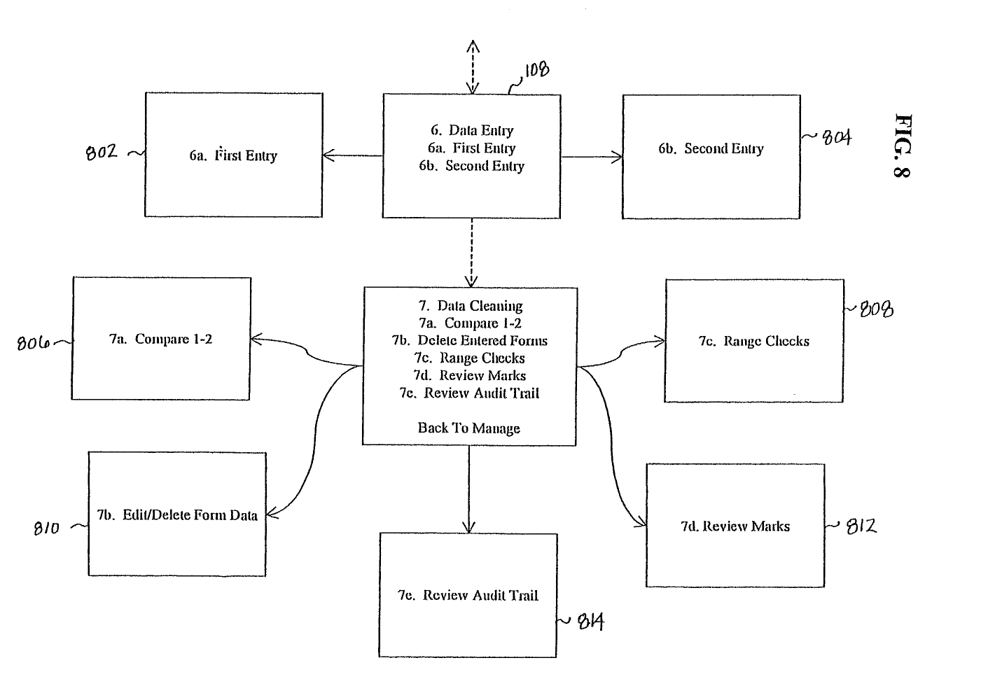

The data management portion of manage component 108 is illustrated in FIG. 8. In the exemplary embodiment, this portion is software enabling users to manage data entry. If the CTDBMS was designed to have double keystroke data entry, the user will enter data twice: a first entry shown at box 802 and a second entry shown at box 804. These entries are then compared, shown at box 806, to check for repeatability as a sign of valid entry. Data may also be verified through range checking, indicated at box 808. Upon validation, or lack thereof, data may be edited or deleted, indicated at 810, reviewed, indicated at 812, and studied in terms of its history since initial entry, indicated at 814.

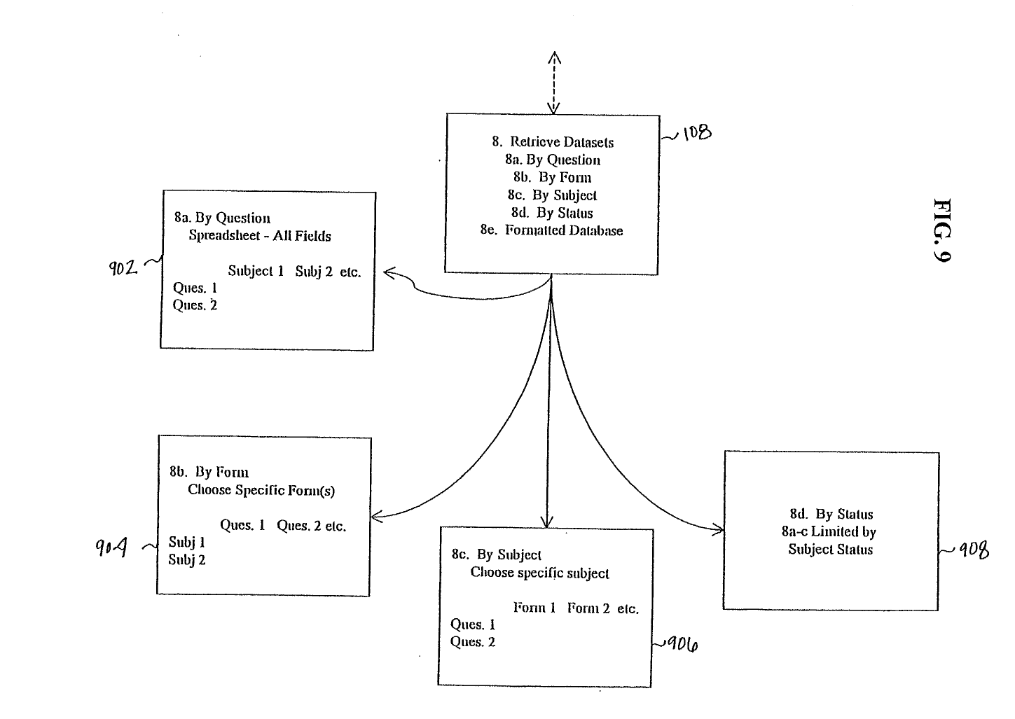

The data retrieval portion of manage component 108 is illustrated in FIG. 9. In the exemplary embodiment, this portion enables a user to retrieve data by a variety of request parameters. For example, data may be retrieved according to question 902, according to form 904, according to subject 906, or according to status 908.

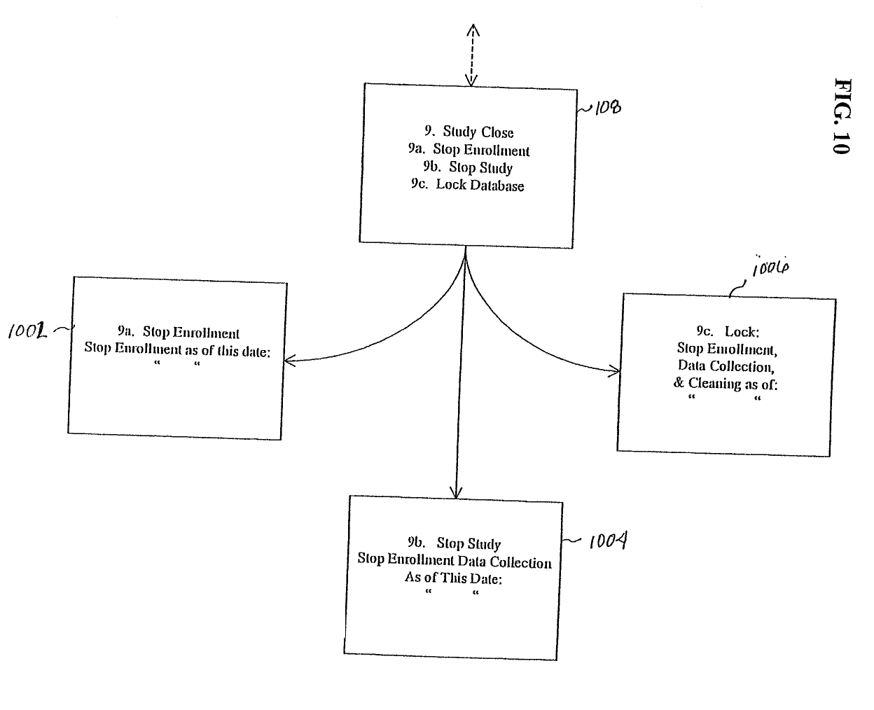

The study completion portion of manage component 108 is illustrated in FIG. 10. In the exemplary embodiment, this portion manages the times during the clinical trial at which enrollment must stop 1002, data collection must stop 1004, and data cleaning must stop 1006.

As discussed above, the present invention includes the capability to combine developer preferences and responses with the conforming guidelines set forth by FDA guidance principles applicable to clinical trials systems. The completed CTDBS, when completed, will therefore conform both to developer specifications and to FDA guidance principles.

For example, FDA guidance suggests that any change to a record should not obscure the original information, and that all such changes should be clearly indicated. Therefore, CTDBMS created according to the present invention have the ability to retain all data entries made by users. For example, edits and updates to data are marked as current value while the original entry is retained and marked as historical and edited data. Additionally, users of a CTDBMS created according to the present invention are able to easily access this historical data, such as through on-screen links and reports. FDA guidance further suggests that changes to data will always require an audit trail in accordance with 21 CFR 11.10(e). Accordingly, CTDBMS created by methods of the present invention include the ability to prompt users to enter rationale for edits at the time edits are made. These rationale entries are stored in connection with user identification and timestamp to provide full audit trail information. FDA guidance also suggests that data should be retrievable in such a fashion that all information regarding each individual subject in a study is attributable to that subject. Therefore, CTDBMS according to the present invention include the ability to mark each data entry with a study subject's identification, allowing easy retrieval and attribution of all trial data. This may be accomplished, for example, by combining a user's input regarding study subject identification with the FDA guidance. That is, a CTDBMS according to the present invention will require study subject identification information from a user, and that information will be utilized by the CTDBMS to mark data entry associated with that study subject.

Among numerous other areas, FDA guidance is also directed to data entry. For example, the guidance states that a data entry system should be designed such that users are required to enter electronic signatures, such as combined identification codes/passwords, at the start of a data entry procedure. A CTDBMS according to the present invention, therefore, will be established to require users to log in with a unique username and password before gaining access to the system. Many other FDA guidance principles are addressed by features of the invention already discussed herein. These FDA guidance principles concern, for example, security measures and training issues.

The foregoing description, which has described in detail the manner in which the exemplary software embodiment of the invention would operate, both from the developer's perspective during CTDBMS creation, and from the user's perspective during CTDBMS implementation, provides sufficient guidance to enable one skilled in the art to create such a software package.

Included in the exemplary embodiment of the invention, which is a software package, are a specified knowledge base of clinical trials regulations is coded into the software, and dialogue boxes that are programmed to collect pertinent information from the developer. This collected information is then merged with the rules from the clinical trials regulations knowledge base, and a unique set of “creation rules” is generated by functions in the software. This unique set of creation rules is a computer-generated set of rules that define the collective rules prescribed by the combination of the developer requirements and the clinical trials regulations. The software then uses the collective rules set to generate the CTDBMS software.

In general, use of rules for the automatic development of software is well-known in the art. For example, many programs contain “wizards” that accept user input and perform a function based on that input. The present invention utilizes a similar method, after performing the inventive function of generating the collective rules set. The result is the new and unique ability of an untrained or novice end-user to rapidly build clinical trials data management systems that are compliant with all appropriate regulatory guidances.

The foregoing description of the preferred embodiments of the invention has been presented for the purposes of illustration and description. It is not intended to be exhaustive or to limit the invention to the precise form disclosed. Many modifications and variations are possible in light of the above teaching. For example, database management systems directed to projects other than clinical trials may be utilized by the system of the present invention. Among other possibilities, the invention may be utilized to create database management systems for production of broadcast play lists required to adhere to certain rules or schedules, or even for preparing forms and providing other assistance for the various rule-oriented procedures that must occur during prosecution of a patent. It is intended that the scope of the invention be limited not by this detailed description, but rather by the claims appended hereto.

What is claimed is:

1. A method for creating a customized database management system, the method comprising:
providing a user with at least one question related to an anticipated use of the customized database management system;
receiving at least one answer to the at least one question from the user;
retrieving a set of rules associated with the anticipated use of the customized database management system;
analyzing the at least one answer and the set of rules; and
generating the customized database management system according to the analyzing of the at least one answer and the set of rules.

2. The method for creating a clinical trials database management system of claim 1 wherein the customized database management system is a clinical trials database management system.

3. The method for creating a clinical trials database management system of claim 1 wherein the anticipated use is administration of a clinical trial.

4. The method for creating a clinical trials database management system of claim 3 wherein the set of rules is derived from clinical trials regulations.

5. The method for creating a clinical trials database management system of claim 1 wherein the set of rules governs the at least one answer.

6. The method for creating a clinical trials database management system of claim 5 wherein the generating creates a customized database that is in conformance with the set of rules and the at least one answer.

7. The method for creating a clinical trials database management system of claim 1 wherein the providing a user with at least one question, the receiving at least one answer, the retrieving a set of rules, the analyzing, and the generating are all performed on a common Web site.

8. A creation system for generating a customized database management system, the creation system comprising:
a computer configured to execute a first routine for asking a user at least one question related to a desired application for the customized database management system and for receiving at least one answer to the at least one question from the user;
the computer further configured to execute a second routine for retrieving a set of rules associated with the desired application for the customized database management system;
the computer further configured to execute a third routine for processing an analysis of the at least one answer and the set of rules; and
the computer further configured to execute a fourth routine for generating the customized relational database management system according to the analysis.

9. The creation system of claim 8 wherein the customized database management system is a clinical trials database management system.

10. The creation system of claim 8 wherein the desired application is a clinical trial.

11. The creation system of claim 10 wherein the set of rules is in conformance with clinical trials regulations.

12. The creation system of claim 10 wherein a generated customized database management system is in conformance with the set of rules and the at least one answer.

13. The creation system of claim 9 wherein the asking and receiving are handled by a dialogue box described by software executed by the computer.

14. The creation system of claim 9 wherein the first routine, second routine, third routine, and fourth routine reside at a common Web site.

15. A method for creating a clinical trials database management system, the method comprising:
providing information descriptive of a particular clinical trial;
providing a first set of rules in accordance with clinical trials governing regulations;
generating a second set of rules that conforms to the information and to the first set of rules; and
generating the clinical trials database management system to be compliant with the second set of rules.

16. The method of claim 15 wherein the clinical trials database management system is contained within a Web site.

17. The method of claim 16 wherein the clinical trials database management system is operable on the Web site.

18. The method of claim 15 wherein the information descriptive of a particular clinical trial includes a user name, and data collection specifications.

19. The method of claim 18 wherein the information descriptive of a particular clinical trial further includes specifications for data cleaning.

20. Computer-readable storage media containing computer software that performs the following functions when loaded into and executed on a computer:
presents to a user a question related to a desired application for a customized database management system;
receives from the user an answer to the question;
retrieves a set of rules associated with the desired application for the customized database management system;
analyzes the answer and the set of rules; and
generates the customized relational database management system according to the analysis.
